(19) United States
(12) Patent Application Publication
(10) Pub. No.: US 2006/0281505 A1
(43) Pub. Date: Dec. 14, 2006

(54) Antenna flip assembly

(76) Inventors: Alejandro Candal, Davie, FL (US); Lorenzo A. Ponce De Leon, Lake Worth, FL (US)

Correspondence Address: MOTOROLA, INC., LAW DEPARTMENT, 1303 E. ALGONQUIN ROAD, SCHAUMBURG, IL, 60196, US

(21) Appl. No.: 11/136,151

(22) Filed: May 24, 2005

(51) Int. Cl. H04M 1/00

(52) U.S. Cl. 455/575.7

(57) ABSTRACT

An assembly (200) includes a base assembly (202), a first flip assembly (206) hingeably coupled to the base assembly, a second flip assembly (210) hingeably coupled to the first flip assembly, an antenna (102) carried by the second flip assembly, and a communication device (104) coupled to the antenna.

### FIELD OF THE INVENTION

This invention relates generally to antennas, and more particularly to an antenna flip assembly.

### BACKGROUND OF THE INVENTION

In most radio communication devices, a user's head and/or hand can touch antenna elements carried by the device, thereby degrading antenna performance from its optimal free-field condition.

### SUMMARY OF THE INVENTION

Embodiments in accordance with the invention provide for an antenna flip assembly which can be less susceptible to antenna performance degradation due to interaction with a user.

In a first embodiment of the present invention, an assembly has a base assembly, a first flip assembly hingeably coupled to the base assembly, a second flip assembly hingeably coupled to the first flip assembly, an antenna carried by the second flip assembly, and a communication device coupled to the antenna.

In a second embodiment of the present invention, a selective call radio (SCR) having an antenna, a communication device coupled to the antenna, a processor for controlling operations of the SCR, and an assembly for carrying the antenna, the communication device and the processor. The assembly includes a base assembly, a first flip assembly hingeably coupled to the base assembly, and a second flip assembly hingeably coupled to the first flip assembly, wherein the antenna is carried by the second flip assembly.

In a third embodiment of the present invention, an RF (Radio Frequency) receiver having an antenna, a receiver coupled to the antenna, and an assembly for carrying the antenna and the receiver. The assembly including a base assembly, a first flip assembly hingeably coupled to the base assembly, and a second flip assembly hingeably coupled to the first flip assembly, wherein the antenna is carried by the second flip assembly.

### BRIEF DESCRIPTION OF THE DRAWINGS

FIG. 1 depicts elements of a selective call radio (SCR) according to an embodiment of the present invention.

FIGS. 2-6 depict housing assembly elements of the SCR and aspects thereof according to an embodiment of the present invention.

FIG. 7 depicts a balun structure used with an antenna of the SCR according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

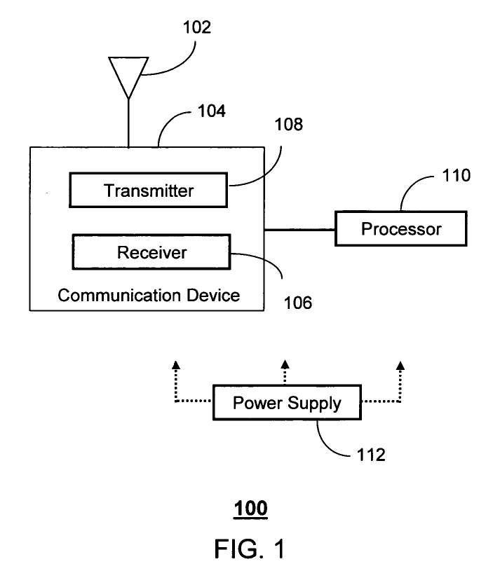

FIG. 1 depicts a selective call radio (SCR) 100 according to an embodiment of the present invention. The SCR 100 comprises an antenna 102, a communication device 104, a power supply 112, and a processor 110 for controlling operations thereof. The antenna 102 can be any conventional antenna such as, for example, a PIFA (Planar Inverted F Antenna). The communication device 104 includes conventional technology for wirelessly communicating with a conventional communication system such as a cellular network. The communication device 104 can comprise a conventional receiver 106 for processing RF (Radio Frequency) signals intercepted by the antenna 102 and/or a conventional transmitter 108 for transmitting RF signals through the antenna 102 for reception by the communication system. Additionally, the communication device 104 can process single band or multi-band RF signals from the communication system.

The power supply 112 utilizes conventional technology for supplying power to the SCR 100. The power supply 112 can be battery operated or can be coupled to a utility outlet. The processor 110 includes conventional technology such as conventional memory (Random Access Memory, Read Only Memory, and/or Flash), and a microprocessor and/or a DSP (Digital Signal Processor) for processing RF signals with the assistance of the communication device 104. The processor 110 can also include other circuits such as an audio circuit for conveying and processing audible signals, a keypad for manual entry by the end user of the SCR 100, an input port for accessory coupling, a display for conveying visual images, just to name a few.

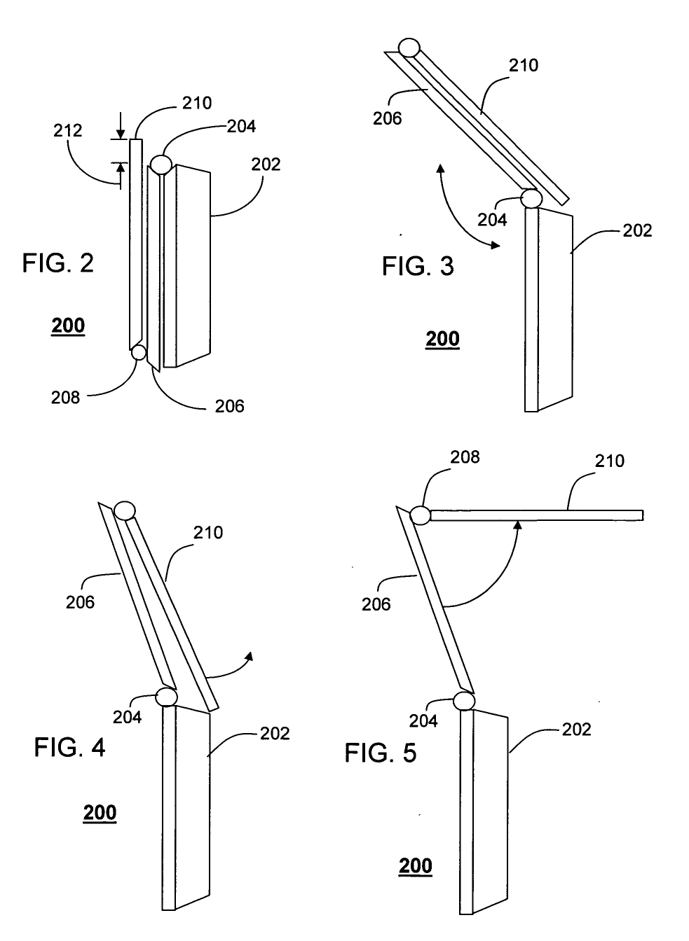

FIGS. 2-6 depict housing assembly elements of the SCR 100 and aspects thereof according to an embodiment of the present invention. FIG. 2 illustrates an assembly 200 for carrying the components 102-112 of the SCR 100. The assembly 200 comprises a base assembly 202 and first and second flip assemblies 206 and 210. In a first embodiment, the base assembly 202 can carry a printed circuit board (PCB) including components of the power supply 112 such as a conventional power converter and a removable battery inserted by way of a battery door of the base assembly 202. The base assembly 202 can further include the processor 110 and its sub-components such as a memory, keypad and portion of an audio circuit.

The first flip assembly 206 can include an audio headset coupled to the audio circuit of the base assembly 202, and a display coupled to a subcomponent of the processor 104. The second flip assembly 210 can include the antenna 102 (shown in FIG. 1), which is coupled to the communication device 104. Portions of the communication device 104 can be carried in whole or in part by the base assembly 202 and the first and second flip assemblies 206 and 210. For instance, the receiver 106 portion of the communication device 104 can be carried by the second flip assembly 210. Alternatively, the receiver 106 can be carried by the first flip assembly 206. Thus, the components 102-112 of the SCR can reside among assemblies 202, 206, and 210 in various arrangements. Although not an enabling requirement for the present invention, sensitivity of the receiver 106 can be enhanced the closer the receiver 106 (and an associated ground plane) is to the antenna 102. The antenna 102 can be positioned anywhere in the second flip assembly 210 such as, for example, at a location farthest way from a hinge 208 or in a middle portion of said assembly.

The foregoing assemblies 202, 206, 210 can be manufactured with any material that satisfies RF requirements for exchanging signals with the communication system, and any other design constraints of the manufacturer of the SCR 100 (e.g., durability, water resistance, etc.).

The first flip assembly 206 is hingeably or pivotably coupled to the base assembly 202 by way of a conventional hinge 204. Hinge 204 can include for instance a conventional cam for rotational alignment of the first flip assembly 206. The cam can be designed to produce a plurality of rotational positions such as closed, mid-open, and fully opened. Electrical connectivity between the circuit components carried by the base assembly 202 and the first flip assembly 206 can be accomplished with a conventional flex PCB such as Kapton. Similarly, the second flip assembly 210 is hingeably or pivotably coupled to the first flip assembly 206 by way of a conventional hinge 208, which can also include a cam for position alignment.

FIG. 2 represents the closed position for the first and second flip assemblies 206 and 210. FIGS. 3-4 depict a representation of a rotational opening of the first flip assembly 206 relative to the base assembly 202. FIG. 3 illustrates the first flip assembly 206 approaching a fully opened position as controlled by, for example, the cam within hinge 204. FIG. 4 represents the first flip assembly in the fully opened position. In a supplemental embodiment, a portion 212 (as shown in FIG. 2) of the second flip assembly 210 extends above the hinge 204 that couples the first flip assembly 206 and the base assembly 202. Portion 212 engages with the base assembly 202 at a predetermined rotational angle separating the first flip assembly 206 from the base assembly 202 when starting from the closed position depicted in FIG. 2. This angle can be for instance 165 degrees. The angle can be varied to achieve on average the greatest distance possible between the end user's head and the antenna 102 in the second flip assembly 210, thereby improving its free-field performance.

FIG. 4 depicts the second flip assembly 210 engaging with the base assembly 202. As the engagement between these assemblies persists, the second flip assembly 210 rotationally separates from the first flip assembly 206 as the predetermined rotational angle increases (see FIG. 5). The rotational setting of the second flip assembly 210 shown in FIG. 5 can be induced by the cam of hinge 208 being triggered by such engagement, or by manual intervention by the user of the SCR 100. FIG. 6 illustrates yet further separation between the first and second flip assemblies 206, 210 which can be created by the user of the SCR 100 so long as hinge 208 provides for such separation.

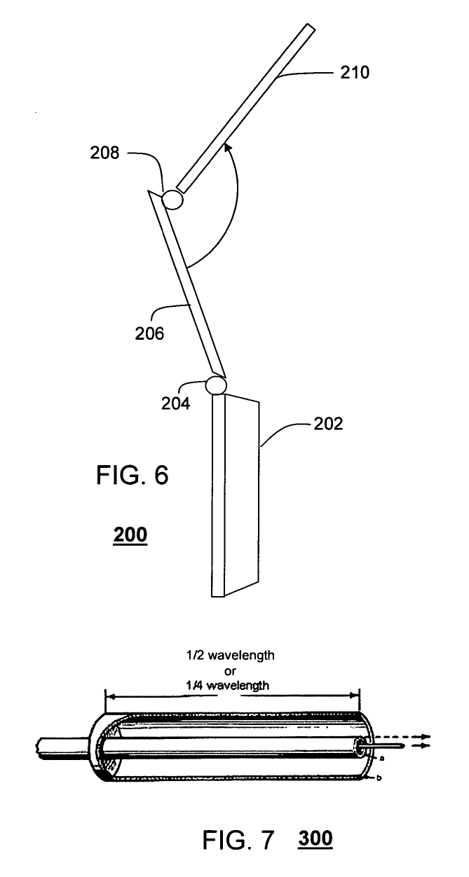

The antenna 102 in the foregoing embodiment can be of any suitable wavelength such as, for example, a quarter-wave antenna or a half-wave antenna. The wavelength selected for the antenna 102 can depend on the grounding scheme used in the SCR 100, materials used in the sub-assemblies 202-210, positioning of the receiver 106 in said assemblies, and other commonly known variables in antenna design. Additionally, conventional techniques can be used to limit signal losses induced by the sub-assemblies 202-210 and/or human body parts. For instance, the antenna 102 and the communication device 104 can be differentially coupled to each other with a balun structure 300 as shown in FIG. 7. The balun structure 300 of FIG. 7 is only for illustration purposes only. Accordingly, other miniaturized structures can be used in lieu of structure 300. The balun structure 300 provides a conventional means for suppressing currents that can interfere with the performance of the antenna 102. One or more balun structures 300 can be located in the first or second flip assembly 206, 210 as needed. It will be appreciated by one of ordinary skill in the art that other techniques and/or other balun structures can be utilized for differential coupling between the antenna 102 and the communication device 104.

In a supplemental embodiment, a second conventional antenna can be included in the first flip 206. In this embodiment, the communication device 104 can select between the antennas of the first and second flip assemblies 206, 210 for processing signals intercepted thereby. Conventional antenna diversity algorithms can be applied by the communication device 104 for selecting the best performing antenna.

It should be evident to an artisan with skill in the art that the embodiments of the present invention provide for a means to optimize a free-field condition. That is, with the embodiments herein, losses created by human body parts such as the head and/or fingers of the hand for supporting the SCR 100 can be substantially diminished. For instance, the second flip assembly 210 can be positioned away from the user's head and fingers when rotationally opened as shown in FIGS. 5-6. Where good signal strength is present in the communication system, the user of the SCR 100 need not rotationally open the second flip assembly 210. However, where signal strength is weak and/or interferences are present (e.g., fading, multi-path interference, building interference, etc.) said user can open the second flip assembly 210 to substantially improve reception.

It should be evident that the present invention may be used for many applications. Thus, although the description is made for particular arrangements and methods, the intent and concept of embodiments herein are suitable and applicable to other arrangements and applications not described herein. For example, the SCR 100 can be reduced to a receiving device without a processor 110 employing the above sub-assemblies 202-210. Embodiment 200 can be modified for single RF band applications. The second flip assembly 210 can be made shorter, and hinge 208 can be repositioned in a middle portion of the first flip assembly 206. Alternatively, the rotation of the second flip antenna 210 can be reversed. That is, instead of rotating counterclockwise as in FIGS. 4-6, hinge 208 can be position at an opposite end of the first flip assembly 206 such that the second flip assembly 210 rotates clockwise. Clearly, these modifications to the embodiments and others not disclosed can be implemented without departing from the spirit and scope of the appended claims.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description are to be construed to be inclusive of the scope as defined in the following claims. Thus, reference should be made to the following claims, rather than to the foregoing specification, as indicating the scope of the invention.

What is claimed is:

1. An assembly, comprising:
a base assembly; .
a first flip assembly hingeably coupled to the base assembly;
a second flip assembly hingeably coupled to the first flip assembly;
an antenna carried by the second flip assembly; and
a communication device coupled to the antenna.

2. The assembly of claim 1, further comprising a cam assembly for reactively engaging the hingeably coupled antenna assembly in a plurality of positions.

3. The assembly of claim 1, wherein the communication device is carried in whole or in part by at least one among the base assembly, the first flip assembly and the second flip assembly.

4. The assembly of claim 1, wherein the communication device is one among a group of devices selected from a receiver for processing signals intercepted by the antenna, a transmitter for supplying signals to be radiated by the antenna, and a transceiver for processing signals intercepted by the antenna and for supplying signals to be radiated by the antenna.

5. The assembly of claim 1, wherein the assembly is a selective call radio (SCR), and wherein the antenna is placed in the second flip assembly at a location that minimizes signal interference with human body parts of a user of the SCR.

6. The assembly of claim 1, wherein the antenna and the communication device are differentially coupled to each other with a balun structure.

7. The assembly of claim 1, wherein a portion of the second flip assembly extends above the hinge coupling the first flip assembly and the base assembly, and wherein said portion engages with the base assembly at a predetermined rotational angle separating the first flip assembly from the base assembly, and wherein the second flip assembly rotationally separates from the first flip assembly as the predetermined rotational angle increases.

8. The assembly of claim 1, further comprising a second antenna in the first flip assembly, wherein the communication device selects among the antennas of the first and second flip assemblies for processing signals intercepted thereby.

9. The assembly of claim 1, wherein a portion of the communication device having a ground plane is located in the first flip assembly.

10. The assembly of claim 1, wherein the antenna is one among a group of antennas selected from a quarter-wave antenna and a half-wave antenna.

11. A selective call radio (SCR), comprising:
an antenna;
a communication device coupled to the antenna;
a processor for controlling operations of the SCR; and
an assembly for carrying the antenna, the communication device and the processor, comprising:
a base assembly;
a first flip assembly hingeably coupled to the base assembly; and
a second flip assembly hingeably coupled to the first flip assembly, wherein the antenna is carried by the second flip assembly.

12. The SCR of claim 11, further comprising a cam assembly for reactively engaging the hingeably coupled antenna assembly in a plurality of positions.

13. The SCR of claim 11, wherein the communication device is carried in whole or in part by at least one among the base assembly, the first flip assembly and the second flip assembly.

14. The SCR of claim 11, wherein the communication device is one among a group of devices selected from a receiver for processing signals intercepted by the antenna, a transmitter for supplying signals to be radiated by the antenna, and a transceiver for processing signals intercepted by the antenna and for supplying signals to be radiated by the antenna.

15. The SCR of claim 11, wherein the antenna is placed in the second flip assembly at a location that minimizes signal interference with human body parts of a user of the SCR.

16. The SCR of claim 11, wherein the antenna and the communication device are differentially coupled to each other with a balun structure.

17. The SCR of claim 11, further comprising a second antenna in the first flip assembly, wherein the communication device selects among the antennas of the first and second flip assemblies for processing signals intercepted thereby.

18. The SCR of claim 11, wherein a portion of the communication device having a ground plane is located in the first flip assembly.

19. The SCR of claim 11, wherein the antenna is one among a group of antennas selected from a quarter-wave antenna and a half-wave antenna.

20. An RF (Radio Frequency) receiver, comprising:
an antenna;
a receiver coupled to the antenna; and
an assembly for carrying the antenna and the receiver, comprising:
a base assembly;
a first flip assembly hingeably coupled to the base assembly; and
a second flip assembly hingeably coupled to the first flip assembly, wherein the antenna is carried by the second flip assembly.
